(19) United States
(12) Patent Application Publication
(10) Pub. No.: US 2003/0155219 A1
(43) Pub. Date: Aug. 21, 2003

(54) Actuating element for an electric switch, especially for a steering wheel switch in a motor vehicle

(76) Inventors: Peter Leng, Russelsheim (DE); Paul Junker, Bingen (DE); Hermann Mahr, Waldalgesheim (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/258,044

(22) PCT Filed: Apr. 12, 2001
(86) PCT No.: PCT/DE01/01479

(30) Foreign Application Priority Data
Apr. 20, 2000 (DE) 100 19 842.2
Aug. 26, 2000 (DE) 100 42 065.6

(51) Int. Cl. H01H 3/00

(52) U.S. Cl. 200/17 R

(57) ABSTRACT

An actuating element for an electric switch, especially for a steering wheel switch in a motor vehicle, impinges upon at least one switching contact and is pivotally mounted on a housing of said switch. A firm hinge is provided as a bearing, connecting the actuating element to a latched wall. The wall runs parallel to the wall of the housing or replaces the wall of the housing.

The invention relates to an actuating element for an electrical switch, especially for a motor vehicle steering wheel switch that applies pressure to at least one switching contact and is mounted in such a manner that it can pivot on a housing of the switch.

In general, in order to create a pivotable support for an actuating element of an electrical switch, support-axis stubs are formed perpendicularly to its direction of rotation, these stubs being opposably arranged on the switch and being inserted in corresponding housing recesses. However, the support-axis stubs are relatively prone to break, for which reason a reject can be generated if the actuating element is improperly mounted in the housing. If several such actuating elements are to be housed in a common housing, a corresponding number of support sites must be realized, at a significant manufacturing expense.

The direct connection of an actuating element to a housing via the intermediary of a film hinge is difficult in that the material for the housing must have different material properties from the material suitable for a strip of film. This problem cannot be solved by manufacture in a two-component injection molding process, since the different materials no longer combine sufficiently homogeneously in this process.

The invention addresses the problem of creating an actuating element of the type initially cited that has a small number of individual parts, is mechanically robust, and in addition, is simple and economical to produce and mount.

The invention solves this problem in that a film hinge is provided as the hinge, said film hinge connecting the actuating element to a partition engaged with the housing, the partition either running parallel to a housing wall or replacing a housing wall.

As a consequence of this measure, it is not necessary to provide additional structural components for pivotable support of the actuating element. As a consequence of connecting the actuating element to the partition, it is possible to manufacture this partition from a suitable plastic upon which mechanical demands can be placed that differ in comparison to the material of the housing. For example, a plastic reinforced with glass fibers with high strength is used to manufacture the housing, said plastic not being usable in a film hinge and the visible surface of the actuating element. The actuating element is produced, with the film hinge and the relatively lightly loaded partition, from a non-reinforced plastic that assures the necessary elasticity and a high surface quality necessary for the visible surfaces of the actuating element. Relatively rapid assembly is assured in that the partition can be engaged with the housing. If the partition replaces one of the housing walls, additional material is saved. By comparison, higher housing stability is achieved when the partition is arranged parallel to a housing wall. Selection between these two alternatives is done according to the specific demands on the housing such as, e.g., its installation situation and mechanical load. Furthermore, connection of differently formed actuating elements to a housing is possible after an appropriate change of the die mold, so that given a design change, only the actuating elements are adapted while the housing and the switch parts inserted in it are kept the same.

According to an advantageous further development of the concept of the invention several actuating elements are arranged parallel to each other perpendicularly to the longitudinal axis of the housing, those actuating elements each being connected to the partition via at least one film hinge. As a result, several switching functions are integrated into one housing; of course, a separate switching contact to be pressed is associated with each of the actuating elements.

In order to prevent pivoting of the actuating element counter to its direction in which it is pressed, at least one stop arm is formed on the bottom of the actuating element, said arm extending behind a projection formed on the housing wall opposite the film hinge.

Since the film hinge on the visible side of the actuating element is considered objectionable on visual and tactile grounds, the partition extends into the film hinge and an actuating surface of the actuating element extends substantially perpendicularly from the partition and/or the film hinge. The film hinge is thereby associated with the outermost edge area of the actuating element.

The one end face of the actuating element is preferably aligned flush with the partition and the associated film hinge, and the other end face preferably extends over part of the housing wall opposite the partition. Thus, the entire housing surface and the film hinges are covered by the actuating element or elements.

In order to achieve appropriate positional fixation between the housing and the actuating element, the partition is advantageously guided on the associated, covered housing wall or between opposing, end-face housing walls.

The guide is advantageously designed as a dovetail guide. The dovetail guide assures guidance in two axes, and accordingly provides a precise positioning of the actuating element in relation to the housing.

Several spaced-apart guide ridges of the housing wall, and corresponding guide grooves in the partition, are preferably provided. The guide ridges extend over approximately the entire height of the housing wall, and the guide grooves extend over approximately the entire height of the partition. Rotation of the partition relative to the housing wall is practically excluded by the relatively great lengths of the guides and their spacing apart from each other.

In order to effectively prevent the partition with the actuating element from being pulled off of the housing, at least one clip arm with a clip opening for latching reception of a clip projection formed on the housing wall is advantageously designed in the partition.

According to a further embodiment, perforated projections for attachment between spokes of a steering wheel are provided on a base of the housing, said base holding the switching contacts designed as a microswitch. The entire switch, which can be used, e.g., to control a Tempomat [cruise control], is reliably connected to the steering wheel via the holes by screws.

In order to adapt the geometry of the housing to the installation situation on a steering wheel, the cross section of the housing is advantageously designed in a substantially triangular shape, in which the housing walls of the longitudinal sides form the sides of the triangle, an end-face housing wall forms the base, and the other end-face housing wall essentially forms an arcuate connection of the longitudinal-side housing walls.

The free end faces of the actuating elements opposite the film hinges are advantageously designed in an arc. In this manner, even the actuating elements are adapted to the contour of the steering wheel.

The switching contacts are relatively sensitive components that must be protected from being overloaded by too great a force when the actuating elements are pressed. Therefore, a stop is advantageously associated with each actuating element on the side opposite the film hinge, said stop coming to rest against the end face of the corresponding housing wall upon being pressed.

In order to convert the pivoting movement of the actuating element into a straight-line movement for applying pressure to the microswitch associated with it, a push rod associated with each actuating element for applying pressure to the corresponding microswitch is movably arranged, preferably on one of the housing walls of the longitudinal sides.

Of course, the previously cited features still to be explained in the following can be used not only in the particular combination indicated, but also in other combinations without departing from the scope of the present invention.

The invention is explained in the following using an exemplary embodiment and making reference to the associated drawings.

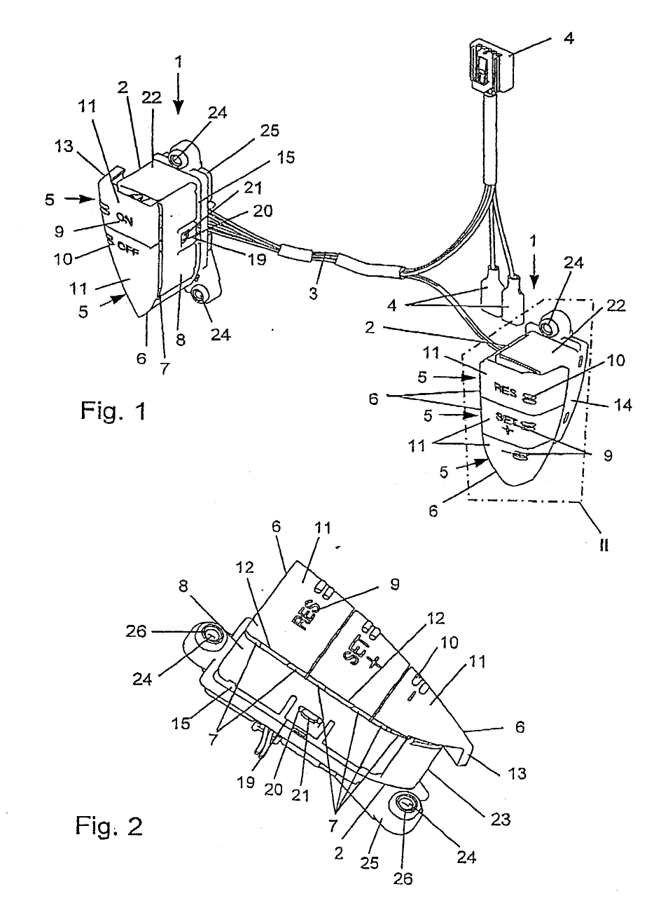

FIG. 1 shows an oblique view of a switch arrangement with actuating elements in accordance with the invention.

FIG. 2 shows an oblique view of a detail II according to FIG. 1.

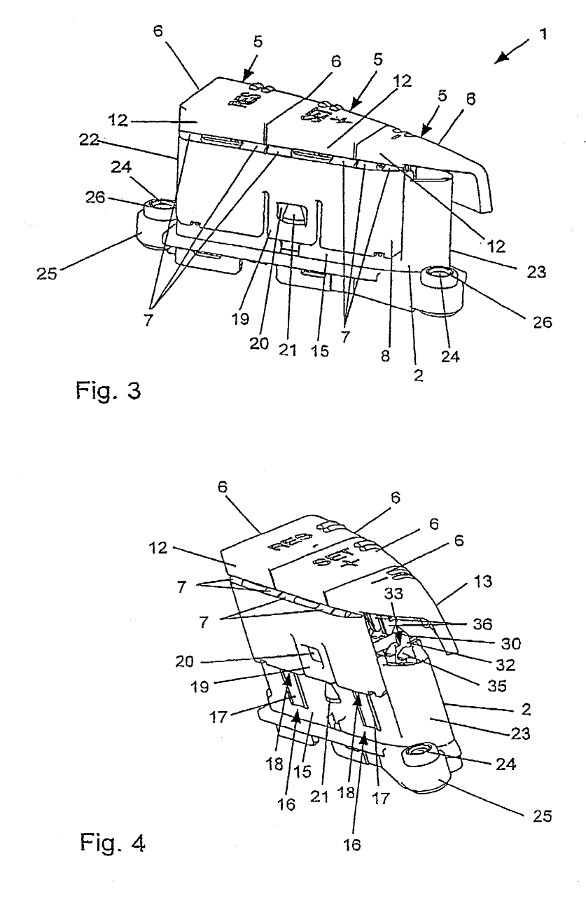

FIG. 3 shows another oblique view of detail II according to FIG. 1.

FIG. 4 shows a partially exploded view of detail II according to FIG. 1.

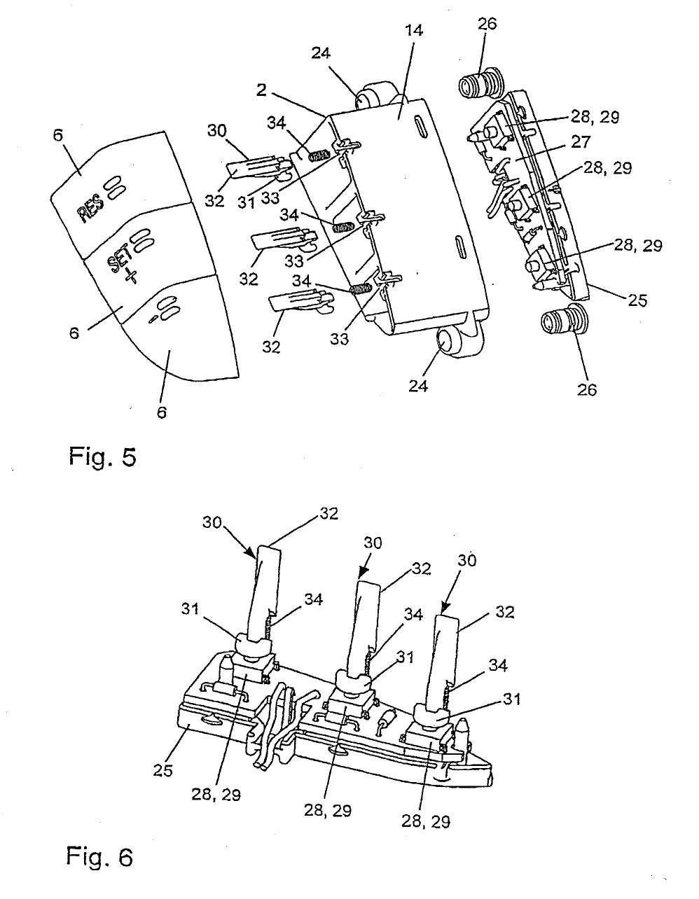

FIG. 5 shows an exploded view of detail II according to FIG. 1.

FIG. 6 shows a view of detail VI according to FIG. 5.

The switch arrangement serves to control a cruise control device, a so-called Tempomat, of a motor vehicle, and comprises two electrical switches 1, each with a housing 2. Switches 1 are connected to one another via leads 3 that end in common plug contacts 4 for connection to the vehicle electrical system. Two individual switches 5 are housed in the one housing 2, of which one serves to cut in the cruise control device and the other to cut it out. The other housing 2 receives three individual switches 5, one of which is provided for resetting the set speed, one for storing the instantaneous speed and increasing it and one for reducing the instantaneous speed of the motor vehicle, by means of the cruise control device. Switches 1 are fastened directly to a steering wheel (not shown) between its spokes so that the driver does not have to remove his hands from the steering wheel when pressing individual switches 5.

Each individual switch 5 comprises a pivotably supported actuating element 6 connected via spaced-apart film hinges 7 to partition 8, which partition 8 also supports the other actuating elements 6 associated with switch 1 via separate and spaced-apart film hinges 7. Partition 8 extends into film hinges 7 and actuating surface 11 of actuating element 6, this surface being provided with symbols 9 and tactilely perceivable elevations 10 and running substantially perpendicularly to partition 8. In order to cover partition 8 and also film hinges 7 such that they are not noticeable in the installed state of switches 1, the one end face 12 of actuating element 6 is aligned flush with partition 8, and thus covers partition 8 and film hinges 7 with actuating surface 11. End face 13 of actuating element 6, which is opposite to partition 8, extends partially over corresponding housing wall 14. Since actuating elements 6, which are arranged parallel to each other, extend for their entire width over the entire upper side of housing 2, the housing is barely noticeable visually in a top view of the switch.

Partition 8 extends parallel to longitudinal-side housing wall 15 and is lodged on it by means of spaced-apart dovetail guides 16. Guide ridges 17 are formed on housing wall 15 and guide grooves 18 corresponding to them are let into partition 8, said guide ridges 17 extending over approximately the entire height of housing wall 15 and said guide grooves extending over approximately the entire height of partition 8. In order to effectively secure partition 8 with associated actuating elements 8 to housing 2, clip arm 19 with clip opening 20 is formed in partition 8 into which opening a corresponding clip projection 21 of housing wall 15 engages.

In order to achieve a harmonious integration of switch 1 with the steering wheel, the cross-sectional area of housing 2 is designed substantially triangularly, with longitudinal-side housing walls 14, 15 forming the sides of the triangle, end-face housing wall 22 the base, and the other end-face housing wall 23 substantially forming an arcuate connection between longitudinal-side housing walls 14, 15. Fastening of switch 1 is effected via perforated projections 24 formed in housing 2 which receive a snapped-in socket 25. Metallic threaded sleeves 26 are inserted into holes 24.

Base 25 carries guide plate 27 with switching contacts 29 designed as microswitches 28, a separate microswitch 28 being associated with each individual switch 5. Push rod 30 is provided for actuating microswitch 28. Push rod 30 comprises receptacle 31 partially surrounding microswitch 28, which receptacle is connected to guide surface 32 running perpendicularly to it. Guide surface 32 is movably guided in substantially T-shaped groove 33, which groove 33 receives pressure spring 34 at the same time, said spring being supported between underside 35 of guide surface 32 and the bottom of groove 33. Projections 35 are formed on housing wall 14 on both sides of groove 33 and corresponding stop arms 36 extend behind these projections. The stop arms 36 are formed on the bottom of actuating element 6.

When actuating element 6 is pressed, it pivots on associated film hinge 7 and pushes push rod 30 against the force of pressure spring 34 in groove 33 in the direction of microswitch 28. An actuating element stop (not shown) comes to rest against the housing in a pressed end position of actuating element 6, whereby microswitch 28 is protected from mechanical overloading, and receptacle 31 of push rod 30 actuates microswitch 28. After actuating element 6 is released, it pivots back into an un-pressed end position as a result of the force of pressure spring 34 acting on push rod 30, and the stop arms of actuating element 6 come to rest against associated projections 35 of housing wall 14.

1. An actuating element for an electrical switch, especially for a motor vehicle steering wheel switch that applies pressure to at least one switching contact (29) and is mounted in such a manner that it can pivot on a housing (2) of the switch, characterized in that a film hinge (7) is provided as the pivot, said film hinge connecting the actuating element (6) to a partition (8) engaged with the housing (2), the partition (8) either running parallel to a housing wall (15) or replacing a housing wall.

2. The actuating element according to claim 1, characterized in that several actuating elements (6) are arranged parallel to each other perpendicularly to the longitudinal axis of the housing (2), these actuating elements each being connected to the partition (8) via at least one film hinge (7).

3. The actuating element according to claim 1 or 2, characterized in that at least one stop arm (36) is formed on the bottom of the actuating element (6), said arm extending behind a projection (35) formed on the housing wall (14) opposite the film hinge (7).

4. The actuating element according to one of claims 1 to 3, characterized in that the partition (8) extends into the film hinge (7) and an actuating surface (11) of the actuating element (6) extends substantially perpendicularly from the partition (8) and/or the film hinge (7).

5. The actuating element according to claim 4, characterized in that the one end face (12) of the actuating element (6) is aligned flush with the partition (8) and the associated film hinge (7), and the other end face (13) extends over part of the housing wall (14) opposite the partition (8).

6. The actuating element according to one of claims 1 to 5, characterized in that the partition (8) is guided on the associated, covered housing wall (15) or between opposing end-face housing walls (22, 23).

7. The actuating element according to claim 6, characterized in that the guide is designed as a dovetail guide (16).

8. The actuating element according to claims 6, 7, characterized in that several spaced-apart guide ridges (17) of the housing wall (15) and corresponding guide grooves (18) in the partition (8) are provided, said guide ridges (17) extending over approximately the entire height of the housing wall (15) and said guide grooves (18) extending over approximately the entire height of the partition (8).

9. The actuating element according to one of claims 1 to 8, characterized in that at least one clip arm (19), with a clip opening (20) for latching reception of a clip projection (21) formed on the housing wall (15), is formed in the partition (8).

10. The actuating element according to one of claims 1 to 9, characterized in that perforated projections (24) for attachment between spokes of a steering wheel are provided on a base (25) of the housing (2), said base holding the switching contacts (29) designed as a microswitch (28).

11. The actuating element according to one of claims 1 to 10, characterized in that the cross section of the housing (2) is designed substantially in a triangular shape, in which the housing walls (14, 15) of the longitudinal sides form the sides of the triangle, an end-face housing wall (22) forms the base, and the other end-face housing wall (23) essentially forms an arcuate connection of the longitudinal-side housing walls (14, 15).

12. The actuating element according to claim 11, characterized in that the free end faces (13), opposite the film hinges (7), of the actuating elements (6) are designed in an arc.

13. The actuating element according to one of claims 1 to 12, characterized in that at least one stop is associated with each actuating element (6) on the side opposite to the film hinge (7), said stop coming to rest against the end face of the corresponding housing wall (14) when pressure is applied.

14. The actuating element according to one of claims 1 to 12, characterized in that a push rod (30), associated with each actuating element (6), for applying pressure to the corresponding microswitch (28) is movably arranged on one of the housing walls (14, 15) of the longitudinal sides.
